(19) United States
(12) Patent Application Publication
(10) Pub. No.: US 2010/0118129 A1
(43) Pub. Date: May 13, 2010

(54) CONTROLLABLE LIGHTING DEVICE FOR AN AUTOSTEREOSCOPIC DISPLAY

(76) Inventor: Sebastien Amroun, Den Haag (NL)

Correspondence Address: Saul Ewing LLP (Philadelphia), Attn: Patent Docket Clerk, 2 North Second St., Harrisburg, PA, 17101, US

(21) Appl. No.: 12/374,210

(22) PCT Filed: Jul. 10, 2007
(86) PCT No.: PCT/EP07/57026

§ 371 Date: Dec. 22, 2009

(30) Foreign Application Priority Data
Jul. 20, 2006 (DE) 10 2006 033 548.1

(51) Int. Cl. H04N 13/04

(52) U.S. Cl. 348/58; 348/E13.075

(57) ABSTRACT

An autostereoscopic display is disclosed, in which light radiated from activated illumination elements of a light modulator is projected by an imaging means in a parallel ray bundle directed by an image reproduction matrix to one eye of a viewer as region of visibility in each case. It may be used in autostereoscopic displays so that image information for several viewers can be represented selectively either in 2D or 3D mode or in mixed mode. A multitude of illumination elements is assigned to each imaging element of the imaging means. Those illumination elements are determined that are required to generate parallel ray bundles for the current viewer position. Slight differences in the number of being activated illumination elements result in imaging disturbances in form of stray light. The stray light illuminates not only the accompanying lenticule but also adjacent lenticules, generating additional secondary parallel ray bundles.

The invention relates to a transmissive autostereoscopic display with a controllable illumination device which contains a light modulator functioning as an illumination matrix. The light radiated from said light modulator is projected in parallel ray bundles by an imaging means through an image reproduction matrix directed onto one eye of a viewer as a region of visibility in each case from which a 3D image representation is seen.

The field of application of the invention is autostereoscopic displays whereby image information such as images or image sequences can be represented for several viewers selectively either in 2D or 3D mode or in mixed mode.

In this document, displays are designated as autostereoscopic displays when at least one viewer can view a 3D image representation without using additional aids.

Basically the display includes an imaging means which consists of a multitude of imaging elements arranged as a matrix. Synchronous to the illumination directed to each viewer eye, the corresponding stereo images for generating a 3D image are represented on the image reproduction matrix. The position of the respective viewer eye is determined by a position finder. When a viewer changes his or her position the regions of visibility are tracked to the viewer eyes by modifying the corresponding control signals of a control unit.

The viewer, or viewers, respectively, are with their eyes in the viewer space in regions out of which image information on the display can be viewed three-dimensionally, said regions referred to as regions of visibility. For viewing from these regions of visibility, the homogeneity of the image representation on the display is to be constantly ensured and cross-talk to the other eye avoided during 3D representation. Also when the viewer takes a new position in the viewer space in front of the display, the above mentioned requirements continue to apply in order to make available to him or her information with monoscopic or stereoscopic image contents in constantly good quality.

The structure and function of such an autostereoscopic display with time-sequential representation are exactly described, for example, in the applicant's WO 2005/060270 A1, being partly reported here.

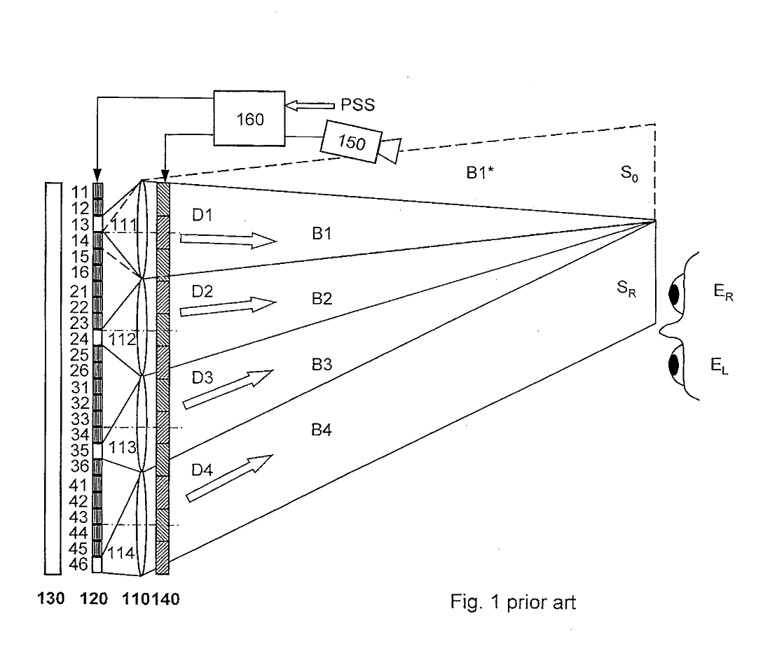

In FIG. 1, the working principle of the display is schematically illustrated in top view, but neither to scale nor containing the full number of optical elements.

A multitude of lens elements 111 . . . 114 in a imaging matrix 110 project switchable point shaped illumination elements 11 . . . 46 of an illumination matrix 120 onto a viewer's eyes E_{R}, E_{L}. Being illuminated by a large-area light source 130, the illumination matrix 120 generates at least one bundle of rays B1 . . . B4 per lens element and viewer, said bundles of rays superimposing to form a two-dimensional sweet-spot (region of visibility) S_{R} at the position of the viewer's eyes due to selective activation of illumination elements 11 . . . 46 by a tracking and image controller 160. The imaging matrix 110, the illumination matrix 120 and the light source 130 together create a controllable sweet-spot unit in the form of a directed backlight to render an image of a transmissive LCD image matrix 140 visible from positions in the viewing space, which are targeted by the tracking and image controller 160. In practice, far more lens elements 111 . . . 114 and illumination elements are provided. Pixels, or sub-pixels, respectively, of an LCD matrix are advantageously used as illumination elements.

On their way to the viewer, the ray bundles B1 . . . B4 permeate large areas of the image matrix 140, which alternately contains only one image of a stereoscopic image sequence of an image signal PSS. A position finder 150 determines the number of viewers and their eye positions E_{R}, E_{L} in front of the display. Accordingly, the tracking and image controller 160 activates, in the example shown, the illumination elements 13, 24, 35 and 46, in order to render the current image of the image sequence visible. As shown in FIG. 1, the illumination elements 13, 24, 35 and 46 are differently positioned relative to the optical axes of the subsequent lens elements. When a viewer moves, the tracking and image controller 160 will activate other illumination elements so as to track the respective sweet-spot bundle according to the dislocation of the eyes. For alternating representation of the stereo images the tracking and image controller 160 renders the subsequent image visible for the respective eye(s) of one or all viewers by switching the illumination elements synchronised with each image change. For the other eye the image is not illuminated for this period of time, hence being invisible. If the image sequence for right and left eyes provided by the image matrix and the synchronised imaging onto the respective eyes is projected sufficiently fast, the viewers' eyes can no longer reach time resolution of the images presented to them. Both eyes perceive the image sequence as a stereo representation.

The ray bundles B1 . . . B4 practically propagate in a way that every active illumination element 13, 24, 35 and 46 is projected onto the plane of the eye positions E_{R} or E_{L}, enlarged to a diameter of at least several millimetres. For the sake of simplicity of the illustration of the working principle, in all figures of this document parallel ray bundles form the sweet-spot (region of visibility). However, in practice the light path deviates slightly from collimation. In any case, the sweet-spot unit is arranged so that each of the bundles of rays B1 . . . B4 covers at least the extension of the sweet-spot area, which is at least as large as a viewer's eye. This allows a viewer to view the entire display area of the image matrix at homogeneous illumination.

In order to meet the above mentioned requirements of the display, a tracking system is necessary which constantly detects the viewers' movement in the space in front of the display within a space region as large as possible, and constantly provides each viewer with the appropriate image information independent of his or her current position by means of the control signals of the control unit. That establishes great requirements for the accuracy of the position finder, the quality of the individual components of the display as well as the imaging quality of the display altogether.

For the present invention it is irrelevant whether the illumination device consists of a plurality of illumination elements which are self-luminous or transmitted by light. A multitude of illumination elements is assigned to each imaging element. Employing the method of inverse ray-tracing calculation, the illumination elements are determined that are needed to produce parallel ray bundles for the current viewer position. Already for slight differences in the number of illumination elements to be activated, i. e. if slightly too many illumination elements are activated, disturbances to the imaging occur.

In practice, if a lenticular array is used as the imaging means, it has been found disadvantageous that when the light of the activated illumination elements is projected as a parallel ray bundle by the lenticule selected, additional disturbing stray light (false light) occurs. The light of the activated illumination elements illuminates not only the particular lenticule, but also both lenticules adjacent to the right and left of the particular lenticule. This light generates additional secondary parallel ray bundles, which are weaker in intensity, but also can reach viewer eyes. Said secondary parallel ray bundles are particularly disadvantageous for the representation of the stereo images, if several viewers in front of the display want to view a 3D representation. It then happens that a secondary parallel ray bundle of the bundle of parallel rays meant for a right eye falls into the left eye of a neighboring viewer, hence providing this left eye with a right stereo image.

It is the objective of this invention to keep the light scattering as small as possible when in an autostereoscopic display light is projected onto viewer eyes, in order to prevent additional regions of visibility from being produced and avoid mutual influence of the stereo images for the eyes of adjacent viewers, i.e. the cross-talk.

According to the invention, the problem is solved in that two striped polarization sheets a distance from each other are arranged in the light path. The polarization sheets used are configured to have alternating stripes of different polarization direction. Suitably, the stripes of equal polarization of the first and second striped polarization sheets are congruently opposing each other in the direction of light, in order to direct the light in the intended direction, i.e. onto the current position of the respective viewer eye selected. According to an example of the invention, the first striped polarization sheet is arranged on the light exit side of a light modulator acting as an illumination matrix and the second striped polarization sheet is arranged in front of an imaging means, preferably a lenticular array. In this way the additionally produced, weaker glowing secondary parallel ray bundles are suppressed. Further it is necessary that the width of a stripe in both polarization sheets is equal to the width of a lenticule of the lenticular array.

In the example of the invention, the imaging means consists of a lenticular array containing a multitude of spherical lenticules arranged in parallel, and projects the light of each illumination element as bundle of parallel rays through one lenticule of the lenticular array in each case. It is within the scope of this invention that the imaging means can also be a matrix-like arrangement of micro lenses in stripe-form. The striped polarization sheets should be similarly arranged.

The position of the illumination elements to be activated is advantageously determined by an inverse ray-tracing calculation from each viewer eye, whereby at the same time the position of the imaging element to be radiated through of the imaging means will be determined.

The solution of the present invention for suppressing secondary ray bundles is simple and efficient and has proved successful in autostereoscopic displays for several viewers. Therefore, also the accuracy of the tracking for several viewers is improved as well as the quality of 3D representation for each individual viewer.

In the following, the controllable illumination device of an autostereoscopic display with time-sequential representation is described in greater detail. In the drawings, it is shown in top view by

FIG. 1 the working principle of the autostereoscopic display, schematically, as the state-of-the-art;

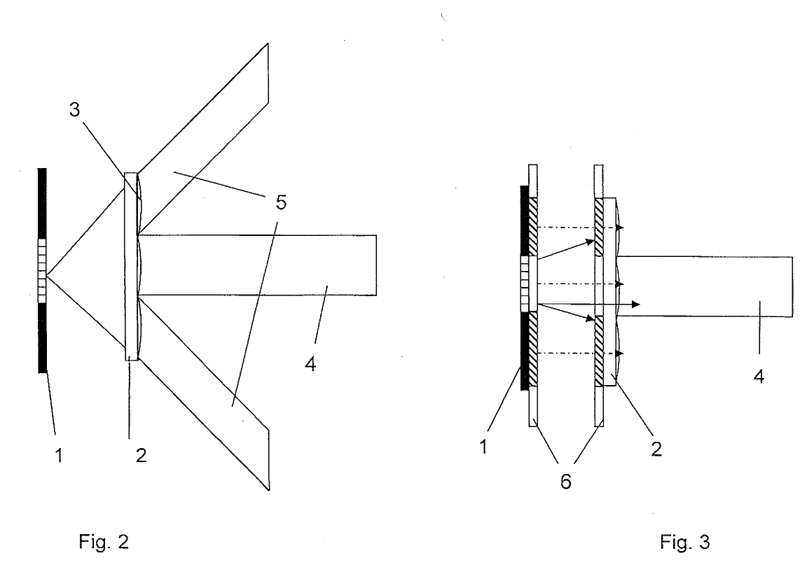

FIG. 2 a schematic representation of a display part with a parallel ray bundle directed onto a viewer eye and two secondary parallel ray bundles additionally produced; and

FIG. 3 a schematic representation to FIG. 2 with means arranged in the light path for suppressing the secondary parallel ray bundles, according to the invention.

The invention is based on an autostereoscopic display the working principle of which according to FIG. 1 has already been described in the state-of-the-art to such an extent that understanding of the present invention is enabled.

In FIG. 2 the illumination light path in the display is schematically illustrated in parts. Marked with 1 the illumination matrix is realized by a light modulator with a multitude of cells arranged matrix-like, which represent the illumination elements. The black regions in the illumination matrix 1 are the non-activated illumination elements. Then, in the direction of light, an imaging means follows configured as lenticular array 2 with parallel adjoining spherical lenticules 3. The light coming from the illumination elements activated column by column is incident on the lenticular array 2. The illumination elements to be activated were determined by inverse ray-tracing calculation according to the current viewer position. The central lenticule of the three spherical lenticules 3 shown directs the light as parallel ray bundle 4 onto a right, or left, viewer eye, respectively, (not shown here), generating a region of visibility for the 3D representation in each eye. However, the light of the activated illumination elements also causes secondary parallel ray bundles 5, which are weaker in intensity. The light of the secondary parallel ray bundles 5 has the same starting point as the parallel ray bundle 4 has. But the secondary parallel ray bundles 5, according to FIG. 2, are radiated at an angle to the right and left of the parallel ray bundle 4. They can lead to the above mentioned deterioration of the projection quality, if several viewers want to see a 3D representation. Namely, for example, a left eye of a second viewer can receive the right stereo image of a first viewer, if the parallel ray bundle 4 synchronously represents a right stereo image controlled time-sequentially. Cross-talk of the stereo representation occurs.

According to FIG. 3, in order to solve the problem, two striped polarization sheets 6 are arranged in the light path of the autostereoscopic display. The first polarization sheet 6 is arranged in the light path in front of the light exit area of the illumination matrix 1 and the second polarization sheet 6 is arranged in front of the lenticular array 2. In order to suppress the secondary parallel ray bundles 5, the stripes of equal direction of polarization of the first and second polarization sheets 6 are congruently arranged opposing each other. The width of the stripes of both polarization sheets 6 is equal to the width of the lenticules 3 of the lenticular array 2. The arrows starting from the activated illumination elements indicate possible directions of light propagation. The first polarization sheet 6 functions as a polarizer, the second polarization sheet as an analyzer. The light is polarized when passing through the first polarization sheet 6 and passes the second polarization sheet 6 as a parallel ray bundle 4. When stray light is incident on the hatched regions of the second polarization sheet 6, the polarized light is not allowed to pass at these places, because it has a different polarization. So no other secondary parallel ray bundles 5 can develop, for the next regions of equal direction of polarization are distanced so far away that practically no stray light hits them.

1. Controllable illumination device for an autostereoscopic display, in which light radiated from activated illumination elements of a light modulator is imaged in a parallel ray bundle by an imaging means through an image reproduction matrix onto one eye of a viewer in each case, whereby
a position finder determines the position of the respective viewer eye;
the imaging means contains a plurality of illumination elements arranged as a matrix and the parallel ray bundle is projected by at least one imaging element; and
synchronously to the respective illumination, corresponding stereo images are represented on the display to create a 3D image,
wherein in the ray path two striped polarization sheets are arranged at a distance from each other, whereby the stripes of both polarization sheets alternately have different directions of polarization and the stripes for the equal direction of polarization are congruently arranged opposing each other so that additionally produced, weaker glowing secondary parallel ray bundles are suppressed.

2. Controllable illumination device of claim 1 wherein the first striped polarization sheet is arranged at the light exit side of the light modulator and a second striped polarization sheet is arranged in front of the imaging means.

3. Controllable illumination device of claim 1 wherein the imaging means is a lenticular array which includes a plurality of parallel arranged lenticules and each parallel ray bundle permeates one lenticule of the lenticular array, whereby the lenticule is determined by inverse ray-tracing calculation.

4. Controllable illumination device of claim 3 wherein the width of the stripes in both polarization sheets is equal to the width of a lenticule of the lenticular array.

5. Controllable illumination device of claim 3 wherein by using the inverse ray-tracing calculation starting from the viewer eye, the position of the illumination elements to be activated and the location of the imaging element to be permeated of the imaging means are also determined.

6. A controllable illumination device for an autostereoscopic display, comprising:
a light modulator having a plurality of illumination elements radiating light when activated;
imaging means, associated with said light modulator, for imaging light radiated from said illumination elements;
an image reproduction matrix associated with said imaging means; and
a position finder determining a position of an eye of a viewer;
wherein:
light radiated from said plurality of illumination elements is imaged in a parallel ray bundle by said imaging means through said image reproduction matrix onto one eye of said viewer;
said plurality of illumination elements are arranged as a matrix and the parallel ray bundle is projected by at least one imaging element;
synchronously to the light being imaged onto one eye of said viewer, corresponding stereo images are represented on the autostereoscopic display to create a 3D image, such that in a ray path of the light being imaged, two striped polarization sheets are arranged at a distance from each other, whereby the stripes of both polarization sheets alternately have different directions of polarization and the stripes for the equal direction of polarization are congruently arranged opposing each other so that additionally produced, weaker glowing secondary parallel ray bundles are suppressed.
